(19) United States
(12) Patent Application Publication
(10) Pub. No.: US 2025/0142414 A1
(43) Pub. Date: May 1, 2025

(54) HANDLING SLICE INFORMATION WITH S-NSSAI MAPPING FOR UICC

(71) Applicant: Apple Inc., Cupertino, CA (US)

(72) Inventors: Stanley M. Mayalil, San Jose, CA (US); Arjun Ramesh Shetty, Bangalore (IN); Rajkumar Krishnaperumal, Bangalore (IN)

(73) Assignee: Apple Inc., Cupertino, CA (US)

(21) Appl. No.: 18/926,461

(22) Filed: Oct. 25, 2024

Related U.S. Application Data
(60) Provisional application No. 63/593,766, filed on Oct. 27, 2023.

(51) Int. Cl. H04W 28/20; H04W 28/26; H04W 72/0453; H04W 76/18

(52) U.S. Cl. CPC H04W 28/20; H04W 28/26; H04W 72/0453; H04W 76/18

(57) ABSTRACT

A user equipment (UE) for handling slice information with single network slice selection assistance information (S-NSSAI) mapping for universal integrated circuit card (UICC) processor is provided. The UE operates by determining whether a baseband processor of the UE is in a busy state. Based on a determination that the baseband processor is not in the busy state, the baseband processor sends a fetch message to a UICC processor of the UE, where the fetch message is sent in response to receipt of a proactive-command-pending message from the UICC processor. The baseband processor receives a proactive-command message from the UICC processor, where the proactive-command message corresponds to a request for single network slice selection assistance information (S-NSSAI) information corresponding to one or more network slices. Finally, the baseband processor sends a response message with the S-NSSAI information to the UICC processor.

### CROSS REFERENCES

This application claims the benefit of U.S. Provisional Application No. 63/593,766 filed Oct. 27, 2023, titled “HANDLING SLICE INFORMATION WITH S-NSSAI MAPPING FOR UICC,” the content of which is herein incorporated by reference in its entirety.

### BACKGROUND

### Field

The described aspects generally relate to techniques for implementing network slicing in a wireless communication system.

### Related Art

5G New Radio (NR) in wireless communications supports a wide range of use cases and applications operating over various bandwidths along with a diverse set of user equipments (UEs) with different performance and latency requirements. Network slicing is a key architectural concept and technology that enables the creation of multiple virtualized, independent, and logically isolated network instances or slices within a single physical 5G network infrastructure. Each network slice can be customized to meet the specific requirements of different services or applications, or user groups, allowing for efficient resource allocation, optimized performance, and diverse use cases within a shared network.

### SUMMARY

Some aspects of this disclosure relate to apparatuses and methods for handling slice information with single network slice selection assistance information (S-NSSAI) mapping for universal integrated circuit card (UICC). For example, some aspects of this disclosure relate to configuring a baseband processor to provide currently active S-NSSAI mapping, rejected slice information with or without mapping information, configured slice information, and/or allowed slice information to a UICC processor.

Some aspects of this disclosure relate to a UE that has a transceiver configured to enable wireless communication with a base station, and a baseband processor communicatively coupled to a UICC processor and the transceiver. The baseband processor is configured to determine whether the baseband processor is in a busy state either corresponding to registration of the UE with a network, or any other activity. Based on a determination that the baseband processor is not in the busy state, the baseband processor is configured to send a fetch message to the UICC processor, wherein the fetch message is sent in response to receipt of a proactive-command-pending message from the UICC processor. The baseband processor then receives a proactive-command message from the UICC processor, where the proactive-command message corresponds to a request for S-NSSAI specific information corresponding to one or more network slices. The baseband processor then sends a response message with the S-NSSAI information to the UICC processor.

According to some aspects, the proactive-command message is a set up event list command requesting information corresponding to a slice status change event (i.e., slice status change event is provided as part of a set up event list command sent from the UICC requesting event download slice status information from the terminal). According to some aspects, the response message is an envelope command message (e.g., event download slices status message) comprising S-NSSAI information that includes one or more of the following: currently serving s-NSSAI, configured s-NSSAI, rejected S-NSSAI without mapping information, or allowed s-NSSAI with or without mapping information. According to some aspects, the proactive-command message is a provide local information (PLI) command requesting information corresponding to rejected network slices with S-NSSAI information. According to some aspects, the response message is a terminal response message comprising rejected slice information with mapping information or rejected slice information without mapping information. According to some aspects, the PLI command comprises a command qualifier corresponding to rejected slice information with or without mapping information. According to some aspects, the PLI command comprises a command qualifier with a value of seventeen to request rejected slice information. According to some aspects, the first bit of the thirty-seventh byte of a terminal profile message indicates support of PLI rejected slice information. According to some aspects, the proactive-command message is a PLI command requesting information corresponding to network slices with S-NSSAI mapping. According to some aspects, the response message is a terminal response message comprising rejected slice information with or without mapping information and currently active S-NSSAI mapping information. According to some aspects, the response message is a terminal response message comprising rejected slice information, with or without mapping information, and one or more of the following: currently serving S-NSSAI information, allowed S-NSSAI with or without mapping information, or configured slice information.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system implementing techniques for handling slice information with S-NSSAI mapping for UICC, according to some aspects of the disclosure.

FIG. 2 illustrates a block diagram of an example system 200 of an electronic device implementing techniques to handle slice information with S-NSSAI mapping for UICC, according to some aspects of the disclosure.

FIG. 3 illustrates an example case in which a baseband processor fails to provide slice status information to a UICC in response to a set up event list proactive command, according to some aspects of this disclosure.

FIG. 4 illustrates an example case in which a baseband processor fails to provide rejected slice information to a UICC in response to a PLI proactive command, according to some aspects of this disclosure.

FIG. 5 illustrates an example case in which a baseband processor provides current slice status information to a UICC in response to a set up event list proactive command, according to some aspects of this disclosure.

FIG. 6 illustrates an example case in which a baseband processor provides rejected slice information to a UICC in response to a provide local information (PLI) proactive command with a command qualifier, according to some aspects of this disclosure.

FIG. 7 illustrates an example case in which a baseband processor provides rejected slice information to a UICC in response to a PLI proactive command, according to some aspects of this disclosure.

FIG. 8 illustrates an exemplary terminal profile portion to indicate support of PLI rejected slice information, according to some aspects of this disclosure.

FIG. 9 illustrates an exemplary method performed by a UE for handling slice information with S-NSSAI mapping for UICC, according to some aspects of this disclosure.

FIG. 10 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Use case scenarios for 5G NR include enhanced mobile broadband (eMBB), ultra-reliable low-latency communications (URLLC), and massive machine type communications (mMTC). These use cases cover a wide range of applications with highly diverse requirements. For example, eMBB is designed to cater to the large capacities needed to accommodate high user density scenarios, mMTC services are characterized by a massive number of sensors or connected devices that typically transmit low volume of non-delay sensitive data, and URLLC services refer to services that are expected to have exceptionally low latency and extremely high reliability.

Network slicing provides a solution to meet the requirements of all use cases using a common physical network infrastructure. The network infrastructure is divided into multiple network slices to cater to the diverse requirements of various application and services. The 5G NR defines single network slice selection assistance information (S-NSSAI) to uniquely identify a network slice. An S-NSSAI is made up of two fields: SST slice service type (SST) and service differentiator (SD). SST defines the expected behavior of the network slice in terms of specific features and services and SD is an optional field.

Currently, there is no provision in Rel 17 CT6 in 3rd Generation Partnership Project (3GPP) specification to indicate to the universal subscriber identify module (USIM) applet (1) the allowed and/or rejected slices when there is a delayed fetch from baseband for a proactive-command-pending message corresponding to an event download slice status request, (2) the allowed and/or rejected slices if the timing of a requested proactive-command-pending message corresponding to event download slice status from USIM is after a slice is already established, and (3) the rejected slice information with or without mapping information via a terminal response when rejected slice information is requested via provide local information (PLI) command for terminals that may not support event download procedure.

To address the above technological issues, embodiments herein provide techniques for handling slice information with S-NSSAI mapping for UICC, according to some aspects of the disclosure. Some aspects of this disclosure relate to configuring a baseband processor to provide currently active S-NSSAI information, which may include the currently serving information, allowed information, and rejected slice information with or without mapping information, to a UICC processor even when baseband processor delays sending a fetch command and/or when UICC processor delays sending a proactive-command-pending message to the baseband processor. Embodiments herein also describe extending provide local information (PLI) proactive command responses to provide rejected slice information, with or without mapping information, to UICC processor 106.

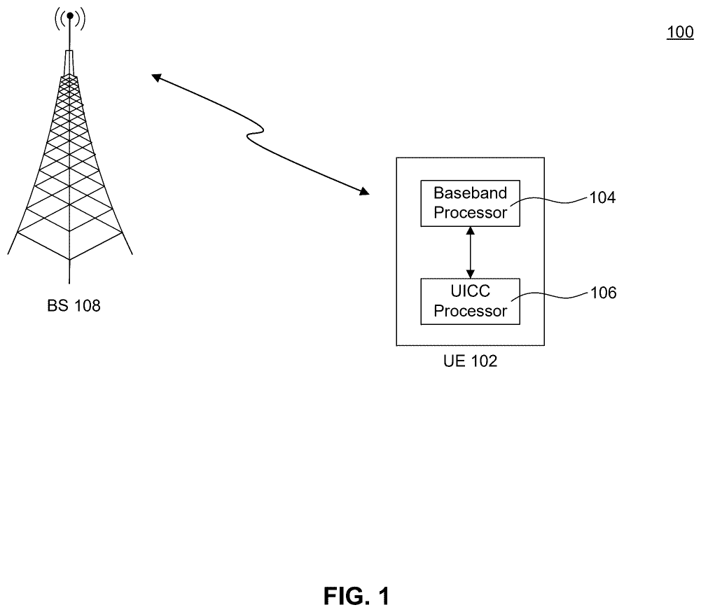

FIG. 1 illustrates an example wireless system 100 implementing techniques for handling slice information with S-NSSAI mapping for UICC, according to some aspects of the disclosure. The example wireless system 100 is provided for the purpose of illustration only and does not limit the disclosed aspects. Wireless system 100 includes, but is not limited to, a base station 108 and a user equipment (UE) 102. UE 102 includes a baseband processor 104 and a universal integrated circuit card (UICC) processor 106. Furthermore, a universal subscriber identify module (USIM) application (commonly known as a “SIM card”) is implemented in the UICC of UE 102. UICC securely stores UE-specific credentials that are required to authenticate a user to the network. In addition, UICC cards enable UE 102 to access appropriate network slices based on service requirements. Baseband processor 104 performs baseband signal processing (e.g., encoding, modulation, data frame formatting, control signaling, etc.) necessary to perform wireless communications with BS 108, often according one more 3GPP standards.

According to some aspects, base station 108 can be a fixed station or a mobile station. Base station 108 may be referred to as a cellular Internet of Things (IoT) base station, an evolved NodeB (eNB), a next generation node B (gNB), a 5G node B (NB), or some other equivalent terminology. In some examples, base station 108 can be interconnected to other base stations or network nodes in a network through various types of backhaul interfaces such as a direct physical connection, a virtual network, and/or the like, not shown.

According to some aspects, UE 102 can be configured to operate based on a wide variety of wireless communication techniques. These techniques can include, but are not limited to, techniques based on 3rd Generation Partnership Project (3GPP) standards. UE 102 can be stationary or mobile. UE 102 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include a robot, a drone, a location tag, and/or the like. Furthermore, UE 102 can be an augmented reality device, a virtual reality device, a mixed reality device, or the like.

According to some aspects, UE 102 may be capable of communicating with one or more base stations of the wireless system 100. According to some aspects, wireless system 100 may utilize one or more radio access technologies (RATs) and may have overlapping coverage from one or more RATs. According to some aspects, base station 108 may be part of a next-generation RAN (NG-RAN). According to some aspects, the base station 108 is an NR base station. An NR radio access network (RAN) includes NR base stations and a new radio core network (CN). An NR base station can be a next generation node B (gNB). UE 102 can access an external network via an NR base station and the NR CN.

According to some aspects, UE 102 accesses multiple network slices over base station 108. A network slice is defined within a public land mobile network (PLMN) and includes resources from both the access network (e.g., NG-RAN) and the core network. A network slice is identified by its S-NSSAI with is a concatenation of an 8-bit SST and a 24-bit slice differentiator. Furthermore, a set of one or more S-NSSAI is referred to as an NSSAI. 3GPP has defined several categories of NSSAI, including configured NSSAI, allowed NSSAI, requested NSSAI, and rejected NSSAI.

Configured NSSAI are a set of S-NSSAI which are available within a specific PLMN. The PLMN may configure UE 102 with one or more configured NSSAI, and UE 102 may use the configured NSSAIs as its default NSSAIs. Up to sixteen S-NSSAIs may be included with a configured NSSAI. Allowed NSSAI are the set of S-NSSAI that the core network has authorized for UE 102. There may be up to eight network slices within an allowed NSSAI, and hence UE 102 can be served by up to eight network slices. Furthermore, using all eight network slices would require the UE to establish eight PDU Sessions. Requested NSSAI are a set of S-NSSAI that UE 102 prefers to access. The requested NSSAI can be either configured or allowed NSSAI or a combination. UE 102 provides the requested NSSAI to base station 108 in a radio resource control (RRC) setup complete message.

Rejected NSSAI is a set of S-NSSAI that UE 102 should not attempt to access. The following NSSAIs are defined by 3GPP: rejected NSSAI for the current PLMN or standalone non-public network (SNPN); rejected NSSAI for the current registration area; rejected NSSAI for the failed or revoked NSSAI; rejected NSSAI for the maximum number of UEs reached; alternative NSSAI and partially rejected NSSAI. According to some aspects, UE 102 may receive a rejected NSSAI information element that identifies one or more rejected S-NSSAIs. Each rejected S-NSSAI includes one S-NSSAI and an associated cause value.

According to some aspects, a proactive UICC (i.e., a UICC that can issue proactive commands) includes a toolkit applet that informs the baseband processor 104, using a proactive-command-pending message that it wishes to send a proactive-command. Baseband processor 104 may send a fetch command to UICC processor 106, and in response to receiving the fetch command, UICC processor 106 sends the proactive command to baseband processor 104. The baseband processor 104 processes the proactive command and sends a response to UICC processor 106 using an envelope command or a terminal response. Proactive commands sent from the UICC processor 106 to the baseband processor may include a setup event list command and a provide local information (PLI) command. Using a setup event list command, UICC supplies a list of events that it wants the baseband processor to provide details of when those events happen (e.g., specific event scheduling, slice establishment, change in the status of a slice). UICC uses a PLI command to request the baseband processor 104 to pass local information to the UICC, for example the network slice information and/or mobile country and network codes of the network on which the user is registered, and which are sent to the baseband processor by the network.

When baseband processor 104 is in a busy state, it delays sending a fetch command to UICC processor 106 in response to a proactive-command-pending message. As a result, baseband processor 104 may not be able to provide currently active S-NSSAI mapping to UICC processor 106 in response to an event download slice status proactive command sent by UICC processor 106. According to some aspects, embodiments herein describe enhancing the event download procedure (e.g., event download slice status change procedure) to configure the baseband processor 104 to provide currently active S-NSSAI, which may include the currently serving slice information, allowed slice information, and rejected slice information with or without mapping information, to UICC processor 106 even when the baseband processor 104 delays sending a fetch command. In addition, when an S-NSSAI is rejected by the network, baseband processor 104 may not be able to provide information regarding the rejected slice to the UICC in a terminal response. The current standards specification does not support providing rejected slice information and/or pre-configured slice information in response to a PLI proactive command. According to some aspects, embodiments herein describe extending the PLI proactive command and corresponding terminal response to provide rejected slice information, with or without mapping information, to UICC processor 106.

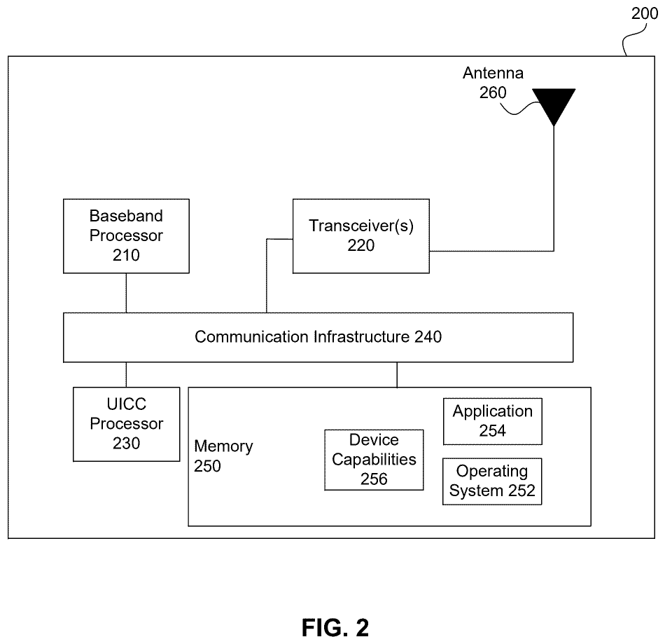

FIG. 2 illustrates a block diagram of an example system 200 of an electronic device implementing techniques to handle slice information with or without respective S-NSSAI mapping for UICC, according to some aspects of the disclosure. System 200 may be represent UE 102 of system 100. System 200 includes baseband processor 210, UICC processor 230, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to baseband processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, radio streaming, video streaming, remote control, and/or other user applications.

System 200 can also include communication infrastructure 240. Communication infrastructure 240 provides communication between, for example, baseband processor 210, one or more transceivers 220a-220n, and memory 250. In some implementations, communication infrastructure 240 may be a bus. Baseband processor 210 and UICC processor 230 together with computer instructions stored in memory 250 performs operations enabling system 200 of system 100 to implement techniques to handle slice information with S-NSSAI mapping for UICC. Alternatively, baseband processor 210 can be “hard-coded” to implement techniques to handle slice information with S-NSSAI mapping for UICC, as described herein.

One or more transceivers 220a-220n transmit and receive communications signals that implement techniques to enhance user experience in low data use case with a WUS on, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, amplifiers, filters, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks such as 5G NR and the like. For example, one or more transceivers 220a-220n can be configured to operate according to one or more of Rel-15, Rel-16, Rel-17, or other of the 3GPP standards.

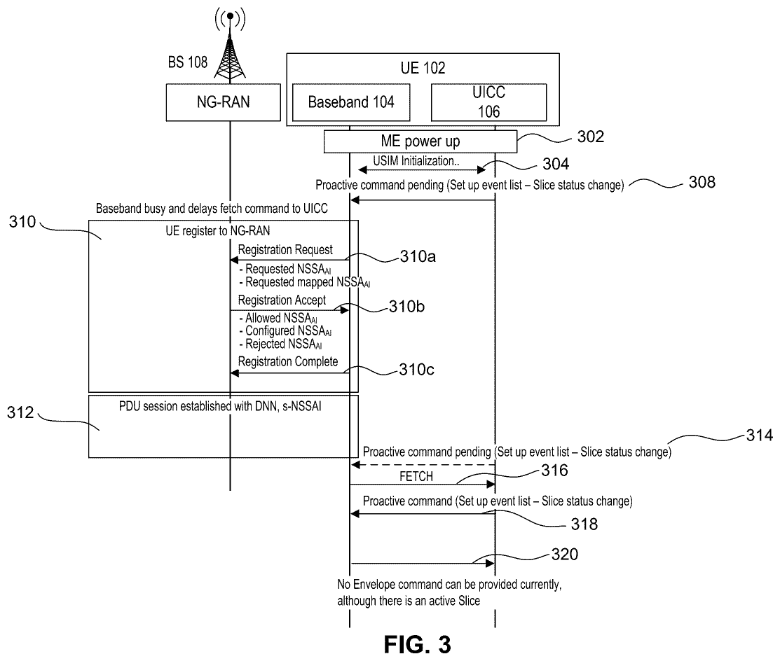

FIG. 3 illustrates an example case in which a baseband processor fails to provide slice status information to a UICC in response to a set up event list proactive command, according to some aspects of this disclosure.

According to some aspects, the UICC 106 of UE 102 is a proactive type UICC and baseband processor 104 supports proactive commands. According to some aspects, when UE 102 is powered up at 302, it triggers the initialization of USIM 304. As part of the USIM initialization process, the UICC processor 106 sends a proactive-command-pending message to the baseband processor 104 at 308. According to some aspects, the proactive-command-pending message 308 may be a setup event list proactive command requesting information corresponding to a slice status change event. The setup event list proactive command is a command to the baseband processor 104 to provide details regarding the served slices, allowed slices and/or the rejected slices whenever baseband processor 104 detects a change in any S-NSSAI status. For example, the S-NSSAI status may change whenever the network provides UE with a new allowed, configured, or rejected s-NSSAI. The proactive-command-pending message may include a status response code 91 xx, where xx indicates the length of the response data (e.g., a proactive command) from UICC. Upon receiving the proactive-command-pending message, baseband processor 104 may sends a fetch command to UICC processor 106 to obtain the information corresponding to the proactive command.

According to some aspects, baseband processor 104 may delay sending the fetch command to UICC processor 106 as shown in 310. For example, baseband 104 may be busy performing UE registration 310 and PDU session establishment 312 with BS 108 and therefore delays sending a fetch command to UICC processor 106. During UE registration 310 to BS 108, baseband processor 104 sends registration request 310a with requested NSSAI and requested mapped NSSAI to BS 108. Subsequently, BS 108 sends a registration accept message 310b with a list of allowed NSSAI, configured NSSAI, and rejected NSSAI to the baseband processor 104. Baseband processor 104 then sends a registration complete message 310c to BS 108 to complete the registration process. Once the registration process is complete, at 312, baseband processor 104 performs PDU session establishment to establish a PDU session associated to an S-NSSAI with a data network name (DNN).

Still referring to FIG. 3, baseband processor 310 exits the busy state once the PDU session establishment 312 is complete and sends a fetch command 316 to UICC processor 106. UICC processor 106 receives the fetch command and sends the set up event list proactive command 318 requesting information corresponding to a slice status change event to baseband processor 104. According to some aspects, baseband processor 104 is expected to provide currently available S-NSSAI information to the UICC processor 106 in response to the set up event list proactive command 318 requesting information corresponding to a slice status change event. However, since baseband processor 104 has already established network slices baseband processor 104 may not be able to send an envelope command that provides current slice information, which may include the currently serving slice information, allowed slice information, rejected slice information with or without mapping information, to UICC processor 106. According to some aspects, baseband processor 104 may not monitor slice status after a successful PDU session establishment. As a result, baseband processor 104 does not provide at 320 currently active S-NSSAI mapping to UICC processor 106 in response to the received set up event list proactive command 318 requesting information corresponding to a slice status change event.

According to some aspects, embodiments provided herein describe enhancing the event download procedure (e.g., event download slice status change procedure) to configure the baseband processor 104 to provide currently active S-NSSAI, which may include the currently serving slice information, allowed slice information, rejected slice information with or without mapping information, to UICC processor 106 even when the baseband processor 104 is busy with registration and therefore delays sending a fetch command in response to receiving a proactive-command-pending message for a set up event list proactive command requesting information corresponding to a slice status change event from the UICC processor 106.

According to some aspects, if the timing of the proactive-command-pending message itself occurs after a slice is already established, then even though baseband processor 104 issues an immediate fetch command to UICC processor 106, the slice information may not be provided to the UICC processor 106. For example, when the proactive-command-pending message 314 is sent to the baseband processor 104 after a slice is established, then the slice information may not be provided to the UICC 106. Even though baseband processor 104 immediately sends the fetch command 316, and

UICC further sends the set up event list proactive command 318 requesting information corresponding to a slice status change event, baseband processor 104 may not be able to provide slice information to the UICC processor 106.

According to some aspects, UICC processor 106 delays sending a pending proactive-command message to the baseband processor 104. As part of the USIM initialization procedure, UICC processor 106 triggers a proactive-command-pending message. However, UICC processor 106 may send the proactive-command-pending message to the baseband processor 104 after the completion of UE registration 310 and PDU session establishment 312. Baseband processor 104 then sends a fetch command 316 to UICC processor 106 and receives the set up event list proactive command 318 requesting information corresponding to a slice status change event from UICC processor 106. However, baseband processor 104 may not be able to provide currently available S-NSSAI information to UICC processor 106 in response to the set up event list proactive command 318 requesting information corresponding to a slice status change event because baseband processor 104 has already established one or more network slices.

According to some aspects, embodiments herein describe enhancing the event download procedure (e.g., event download slice status change procedure) to configure the baseband processor 104 to provide currently active S-NSSAI, which may include the currently serving slice information, allowed slice information, rejected slice information with or without mapping information, to UICC processor 106 even when UICC processor 106 delays sending a proactive-command-pending message to the baseband processor 104.

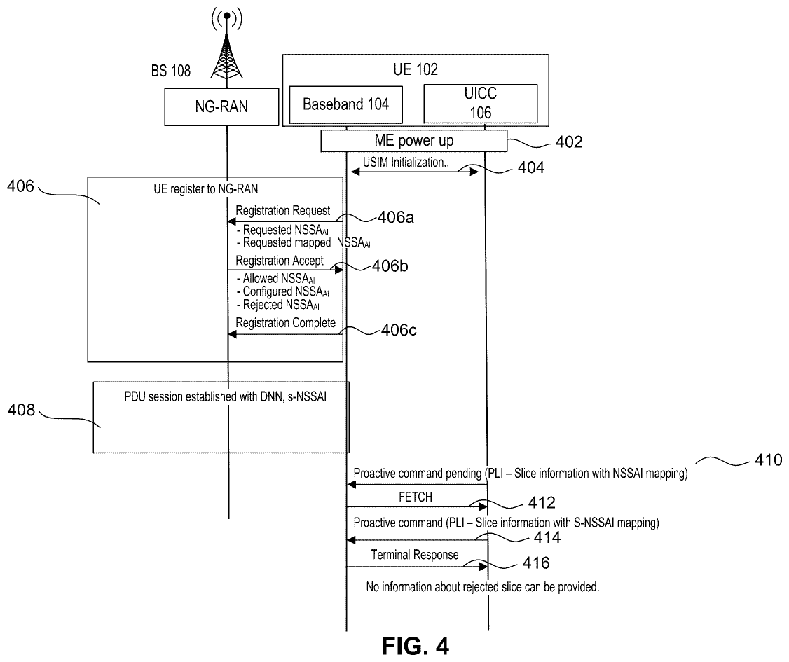

FIG. 4 illustrates an example case in which a baseband processor fails to provide rejected slice information to a UICC in response to a provide local information (PLI) proactive command, according to some aspects of this disclosure.

According to some aspects, the UICC of UE 102 is a proactive type UICC and baseband processor 104 (e.g., terminal of UE 104) may not support some proactive commands. According to some aspects, baseband processor 104 may or may not support event download proactive commands from UICC processor 106. However, baseband processor 104 may support PLI proactive commands. According to some aspects, when UE 102 is powered up at 402, it triggers the initialization of USIM 404. Baseband processor 104 then performs UE registration 406 and PDU session establishment 408. During UE registration 406 to BS 108, baseband processor 104 sends registration request 406a with requested NSSAI or mapped NSSAI to BS 108. BS 108 sends a registration accept message 406b with a list of allowed NSSAI, configured NSSAI, and rejected NSSAI (with or without respective mapping information) to the baseband processor 104. Baseband processor 104 then sends registration complete message 406c to BS 108 to complete the registration process. Once the registration process is complete, baseband processor 104 performs PDU session establishment 408, where UE 102 may establish a PDU session associated with an S-NSSAI with a DNN.

According to some aspects, UICC processor 106 sends a proactive-command-pending message 410 to baseband processor 104, where the proactive-command-pending message may correspond to a PLI command for slice information. The PLI command for slice information with S-NSSAI mapping is a command to the baseband processor 104 to provide details regarding slices with S-NSSAI mapping. Upon receiving the proactive-command-pending message, baseband processor 104 sends a fetch command 316 to UICC processor 106 and receives the PLI proactive command for slice information 414 that is sent from UICC processor 106.

According to some aspects, in response to receiving a PLI proactive command for slice information with S-NSSAI mapping 414 from UICC processor 106, baseband processor 104 sends information corresponding to allowed slices with S-NSSAI mapping. However, if there are any S-NSSAIs that are rejected (i.e., rejected in the current registration area or rejected in the PLMN), baseband processor 104 may not be able to provide information regarding rejected slices in a terminal response 416. The rejected slice information, with or without mapping information, may not be provided because the current standards specification does not support providing rejected slice information in response to a PLI proactive command. Furthermore, the current standards specification also does not support providing information corresponding to configured slices to the UICC processor 106. According to some aspects, embodiments herein describe extending the PLI proactive command and respective responses to provide rejected slice information, with or without mapping information, and/or the configured slice information to UICC processor 106.

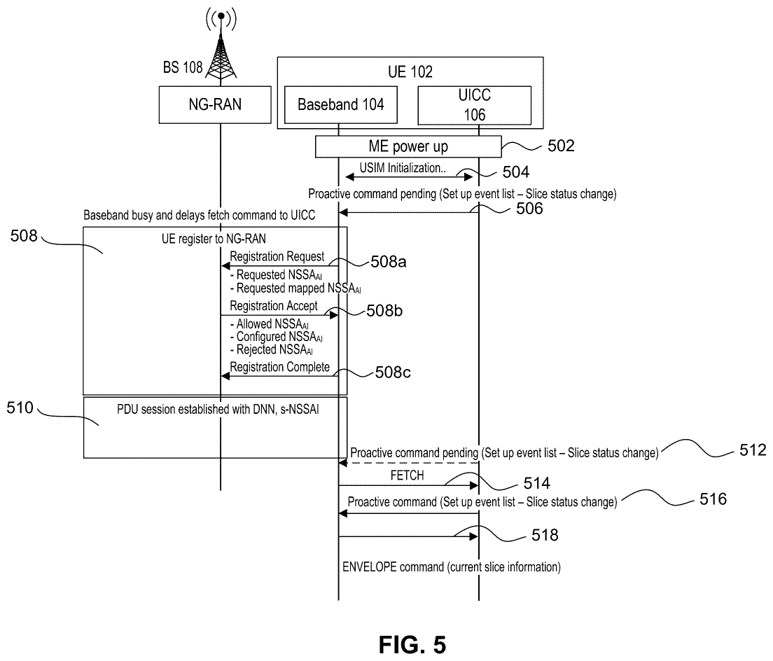

FIG. 5 illustrates an example case in which a baseband processor provides current slice status information to a UICC in response to a set up event list proactive command requesting information corresponding to a slice status change event, according to some aspects of this disclosure.

According to some aspects, when UE 102 is powered up at 502, it triggers the initialization of USIM 504. As part of the USIM initialization process, the UICC processor 106 sends a proactive-command-pending message 506 to the baseband processor 104. The proactive-command-pending message 506 may correspond to a setup event list proactive command requesting information corresponding to a slice status change event. Upon receiving the proactive-command-pending message, baseband processor 104 may send a fetch command to obtain the information corresponding to the proactive command.

According to some aspects, baseband processor 104 may delay sending a fetch command to UICC processor 106. For example, baseband 104 may be busy performing UE registration 508 and PDU session establishment 510 and may delay sending a fetch command to UICC processor 106. According to some aspects, during UE registration 508 to BS 108, baseband processor 104 sends registration request 508a to BS 108. BS 108 then sends a registration accept message 508b, and baseband processor 104 sends a registration complete message 508c to BS 108 to complete the registration process. Once the registration process is complete, baseband processor 104 performs PDU session establishment 510, where UE 102 establishes a PDU session associated to an S-NSSAI with a data network name (DNN).

According to some aspects, baseband processor 104 may be in a busy state due to UE registration 508 and PDU session establishment 510, and it may delay sending a fetch command to UICC processor 106. According to some aspects, baseband processor 104 exits the busy state once the PDU session establishment is complete and sends a fetch command 514 to UICC processor 106. UICC processor receives the fetch command and sends the set up event list proactive command 516 requesting information corresponding to a slice status change event to baseband processor 104.

According to some aspects, the event download procedure (e.g., event download slice status change procedure) is enhanced so the baseband processor 104 provides currently active S-NSSAI mapping to UICC processor 106 even when the baseband processor 104 delays sending a fetch command in response to receiving a proactive command (e.g., set up event list proactive command requesting information corresponding to slice status change event). Accordingly, baseband processor 104 sends an envelope command 518 with current slice information to UICC processor 106, and baseband processor 104 provides all the currently available S-NSSAI information to UICC (e.g., rejected S-NSSAI, allowed S-NSSAI, served S-NSSAI list with or without mapping information), even when baseband processor 104 sends a fetch command after UE registration 508 and PDU session establishment 510. The S-NSSAI information provided to UICC processor 106 may include information corresponding to one or more of the following: the current serving slice with or without mapping, the allowed slices with or without mapping, the rejected slices with or without mapping, or the configured slices.

Still referring to FIG. 5, UICC processor 106 delays sending a proactive-command-pending message to the baseband processor 104 when it is in a busy state. As part of the subsequent USIM initialization procedure, UICC processor 106 triggers a pending-proactive-command message. However, UICC processor 106 sends the pending-proactive-command message 512 to the baseband processor 104 after the completion of UE registration 508 and PDU session establishment 510. Baseband processor 104 then sends a fetch command 514 to UICC processor 106 and receives the set up event list proactive command 516 requesting information corresponding to a slice status change event from UICC processor 106. According to some aspects, baseband processor 104 then sends an envelope command 518 with current slice information to UICC processor 106.

According to some aspects, if the slice status change event is part of the current event, as set up by the set up event list proactive command, then, when baseband processor (e.g., ME) detects a change in any S-NSSAI status (S-NSSAI included to or removed from rejected S-NSSAI, allowed NSSAI or served S-NSSAI list) from the network, the baseband processor shall inform the UICC that it has occurred, using envelope event download-slice status. In case slice status is already available in the UE when the UICC supplies an event list for slice status change event, then the baseband processor shall immediately send the envelop event download slices status. According to some aspects, envelope command 518 may also include currently served NSSAI with or without mapping information, configured slice information available at baseband processor 104.

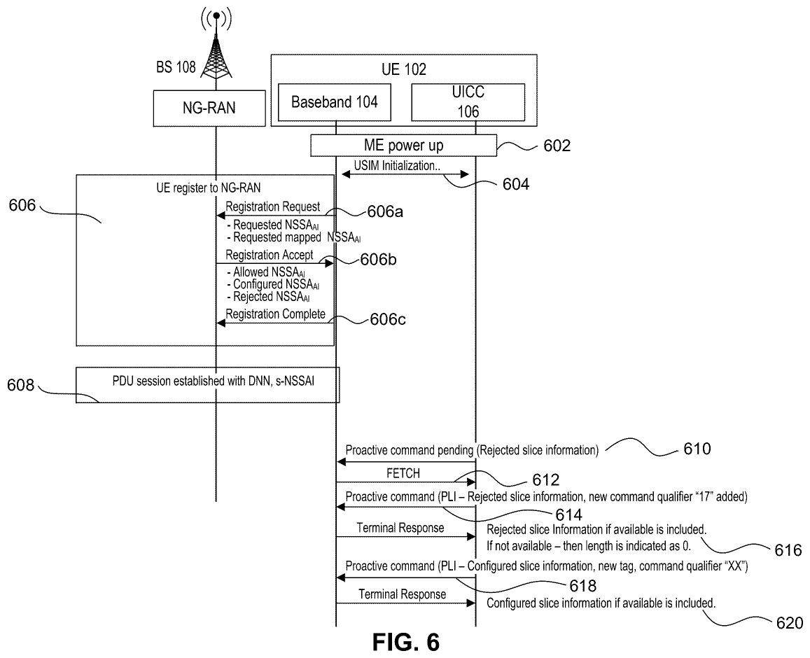

FIG. 6 illustrates an example case in which a baseband processor provides rejected slice information, with or without mapping information, to a UICC in response to a provide local information (PLI) proactive command with a command qualifier, according to some aspects of this disclosure.

According to some aspects, baseband processor 104 may not support an event download proactive commands. However, baseband processor 104 may support PLI proactive commands. When UE 102 is powered up at 602, it triggers the initialization of USIM 604. According to some aspects, after the USIM initialization 604, UE performs registration 606 to BS 108. During UE registration 606, baseband processor 104 sends registration request 606a to BS 108. BS 108 then sends a registration accept message 606b, and baseband processor 104, in turn, sends a registration complete message 606c to BS 108 to complete the registration process. Once the registration process is complete, baseband processor 104 performs PDU session establishment 608, where UE 102 establishes a PDU session associated with an S-NSSAI with a data network name (DNN).

According to some aspects, UICC processor 106 sends a proactive-command-pending message 610 to baseband processor 104, where the pending-proactive-command message 610 may correspond to a PLI command for rejected slice information with or without mapping information. Upon receiving the proactive-command-pending message 610, baseband processor 104 sends a fetch command 612 to UICC processor 106. Upon receiving fetch command 612, UICC processor 106 sends a proactive command PLI 614 for rejected slice information (with or without mapping information) to baseband processor 104.

According to some aspects, proactive command PLI 614 may include a new command qualifier (e.g., an indicator tag) to indicate UICC processor 106 can handle the list of rejected slice information with or without mapping information. According to some aspects, the thirty-seventh byte (e.g., bit 1 of the thirty-seventh byte) of the terminal information may be used to indicate support of PLI rejected slice information with or without mapping information. According to some aspects, terminal information may include in proactive command PLI. According to some aspects, proactive command PLI 614 may include a command qualifier with a value of seventeen to request rejected slice information with or without mapping information. Other bytes and values can be used as will be understood by those skilled in the art.

Still referring to FIG. 6, in response to receiving proactive command PLI 614 for rejected slice information, with or without mapping information, from UICC processor 106, baseband processor 104 sends a terminal response 616 with information corresponding to rejected slice information with or without mapping information. Baseband processor 104 includes rejected slice information, with or without mapping information, in the terminal response 616 if it is available at baseband processor 104. However, if the rejected slice information, with or without mapping information, is unavailable at baseband processor 104, the response length is indicated by a value of zero in terminal response 616.

UICC processor 106 may send a proactive command PLI for configured slice information 618 with a new tag and/or a new command qualifier. Baseband processor 104 may respond with a terminal response 620 with configured slice information if available at baseband processor 104. However, if the configured slice information is unavailable at baseband processor 104, the response length is indicated by a value of zero in terminal response 620.

Alternatively or additionally, UICC processor 106 may send a proactive command PLI for allowed slice information with a new tag and/or a new command qualifier. Baseband processor 104 my respond with a terminal response with allowed slice information if available at the baseband processor 106. However, if the allowed slice information is unavailable at baseband processor 104, the response length is indicated by a value of zero in the terminal response.

According to some aspects, a PLI command with a new qualifier for rejected slice information, with or without mapping information, provides the UICC processor 106 with the flexibility to request rejected slice information with or without mapping information independently of the allowed slice information from baseband processor 104. In addition, a PLI command with a new qualifier for rejected slice information, with or without mapping information, enables baseband processor 104 to send a terminal response of a size less than 255 bytes.

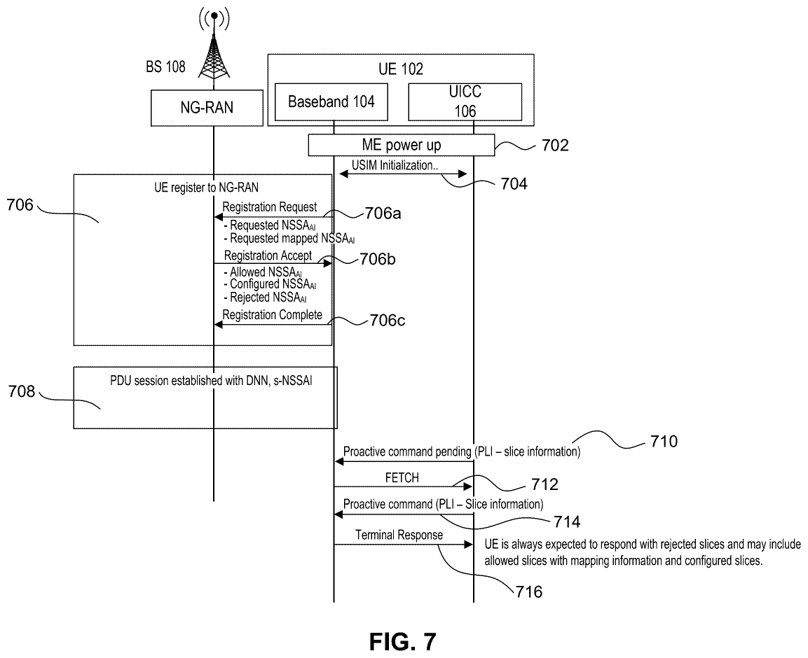

FIG. 7 illustrates an example case in which a baseband processor provides rejected slice information, with or without mapping information, to a UICC in response to a provide local information (PLI) proactive command, according to some aspects of this disclosure.

According to some aspects, baseband processor 104 may not support an event download procedures and related proactive commands. However, baseband processor 104 may support PLI proactive commands. UE 102 is powered up at 702, and after the USIM initialization 704, UE performs registration 706 to BS 108. Baseband processor 104 sends registration request 706a to BS 108. BS 108 then sends a registration accept message 706b, and baseband processor 104, in turn, sends a registration complete message 706c to NG-RAN to complete the registration process. Once the registration process is complete, baseband processor 104 performs PDU session establishment 708.

According to some aspects, UICC processor 106 sends a proactive-command-pending message 710 to baseband processor 104. The pending-proactive-command message 710 may correspond to a PLI command for slice information. Upon receiving the proactive-command-pending message 710, baseband processor 104 sends a fetch command 712 to UICC processor 106. Next, upon receiving fetch command 712, UICC processor 106 sends a proactive command PLI 714 to request slice information to baseband processor 104.

Still referring to FIG. 7, baseband processor 104 then sends a terminal response 716 with a list of rejected slices with or without S-NSSAI mapping information, if available. According to some aspects, the PLI command response is extended to include additional information such as the list of rejected slice with S-NSSAI mapping along with the available currently served S-NSSAI list. According to some aspects, baseband processor 104 is expected to respond with rejected slice information, with or without mapping information, as well as the slice information with S-NSSAI mapping when a proactive command PLI slice information is received. According to some aspects, terminal response 716 may include information corresponding to configured slices, and/or allowed slices with or without mapping of S-NSSAI at UE 102 as well as with serving slices information with S-NSSAI mapping.

According to some aspects, to handle slice information with S-NSSAI mapping for UICC as illustrated in FIGS. 5-7, the following revised clauses may be included in 3GPP TS 131.11:

Clause 5.2: In TERMINAL PROFILE a new bit to indicate support of PROVIDE LOCAL INFORMATION (support to indicate rejected slice information with or without mapping information). Support of PROVIDE LOCAL INFORMATION, Rejected Slice Information with or without mapping information.

Clause 6.4.15: In PLI-add the list of rejected slice(s) information. When the list of rejected slice(s) information, with or without mapping information, is requested, the list of rejected slice(s) information is returned.

Clause 6.8: Rejected Slice information included in TERMINAL RESPONSE, and hence the command header length of Terminal Response is accordingly increased. Rejected Slice Information (only required in response to PROVIDE LOCAL INFORMATION (list of rejected slice(s) information proactive command)

Clause 6.8.7: Local information update to include the rejected S-NSSAI mapping information. Where the UICC has requested the list of rejected slice(s), then TERMINAL RESPONSE shall contain the list of rejected slice(s) information, up to the limit of the TERMINAL RESPONSE APDU command size. If no rejected slice information is available, the respective data object shall have length zero.

Clause 7.5.27.1: Additional condition added that allow baseband to provide the requested slices information in cases where the UE fetches the proactive command later. Incase Slice status is already available in the UE when the UICC supplies an SET UP Event list: with event list for Slice Status Change event (i.e., a set up event list proactive command requesting information corresponding to a slice status change event), then baseband shall immediately send the ENVELOPE (EVENT DOWNLOAD-Slices Status)

Clause 8.6: Command details-Additional value for PLI command qualifier reserved to handle rejected S-NSSAI command.

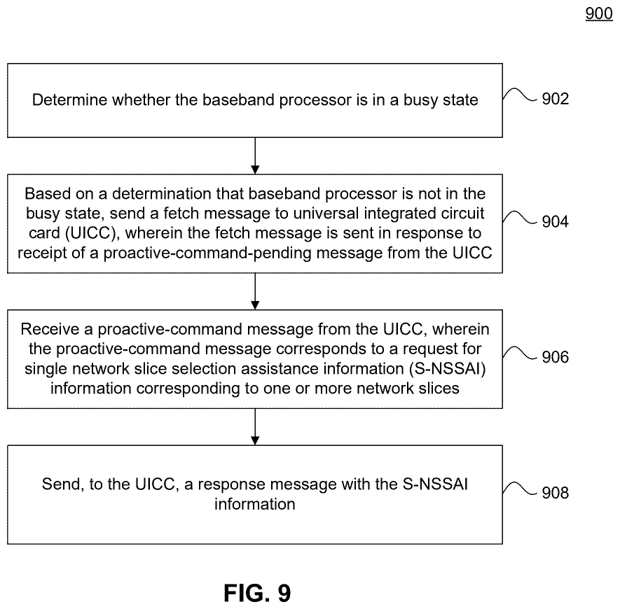

Clause 8.151: Rejected slices do not have mapping information per TS 24.501 clause 9.11.3.46 (Rejected S-NSSAI coding is as per FIG. 9.11.3.46.2—starting from octect 2), hence the clause is corrected to remove this mapping information.

Clause 9.3: ‘Rejected Slice information tag’ name corrected to avoid the usage of wording “mapping information” as per corrected Clause 8.151.

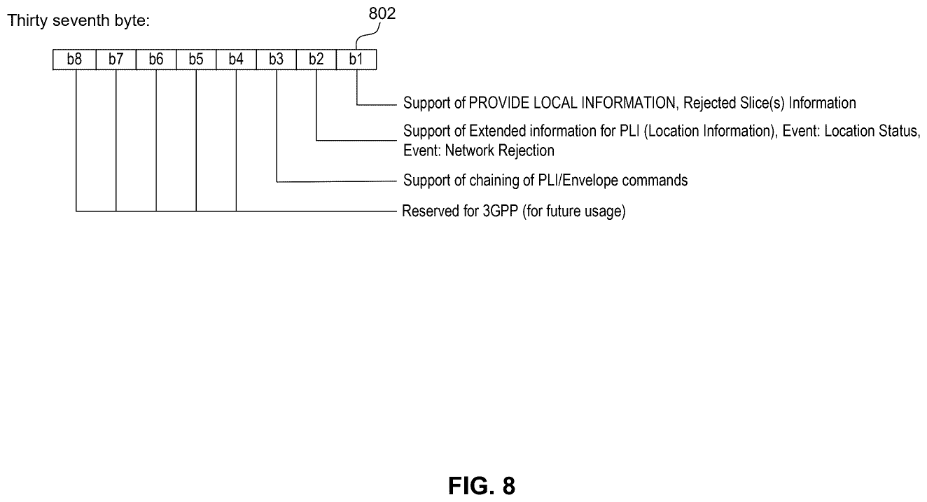

FIG. 8 illustrates an exemplary terminal profile portion to indicate support of PLI rejected slice information, with or without mapping information, according to some aspects of this disclosure. According to some aspects, the thirty-seventh byte of the terminal information is used to indicate support of PLI rejected slice information. According to some aspects, bit b1 802 indicates support of PLI rejected slice information. According to some aspects, proactive command PLI includes a command qualifier with a value of seventeen to request rejected slice information with or without mapping information. The disclosure is not limited to the thirty-seventh byte or a value of 17, other bytes and values can be used as will be understood by those skilled in the art.

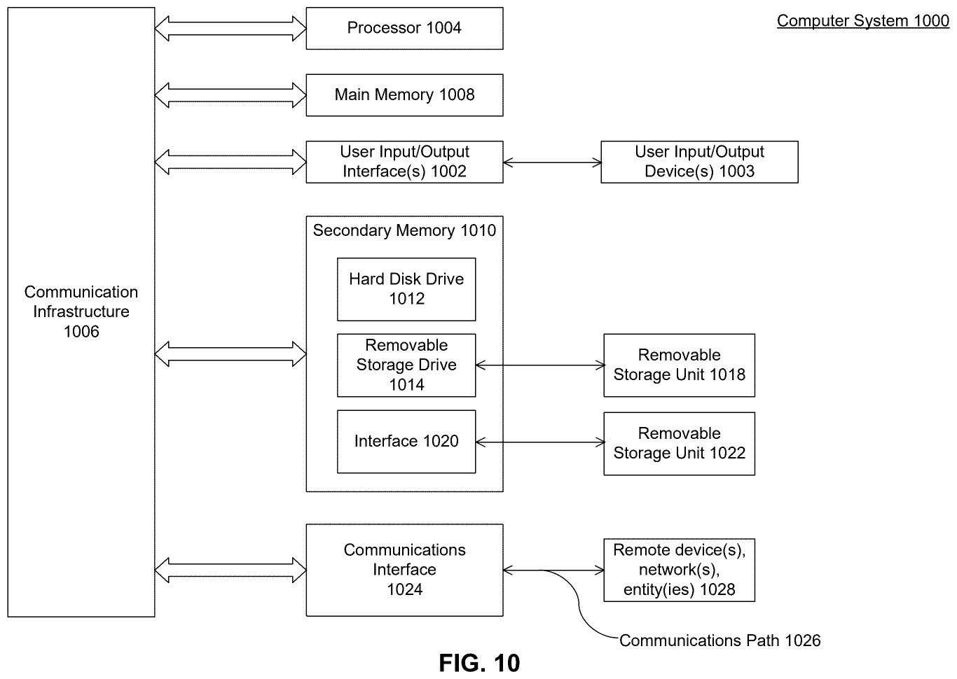

FIG. 9 illustrates an exemplary method 900 performed by a UE for handling slice information with S-NSSAI mapping for UICC, according to some aspects of this disclosure. As a convenience and not a limitation, FIG. 9 may be described with regard to elements of FIGS. 1-8, for example, the functions of FIG. 9 can be performed by UE 102. For example, baseband processor 104 can perform, or cause to perform, the functions of FIG. 9 in conjunction with other elements of FIG. 2. Method 900 can also be performed by system 200 of FIG. 2 and/or computer system 1000 of FIG. 10. But method 900 is not limited to the specific aspects depicted in those figures, and other systems may be used to perform the method as will be understood by those skilled in the art. It is to be appreciated that not all operations may be needed, and the operations may not be performed in the same order as shown in FIG. 9.

At 902, baseband processor 104 determines whether it is in a busy state corresponding to registration of the UE 102 with a network. According to some aspects, baseband processor 104 can be in a busy state due to performing UE registration and PDU session establishment, and can delay sending a fetch command to UICC processor 106. Alternatively or additionally, baseband processor 104 can be in a busy state due to performing any activity that may require baseband processor 104 to delay sending an immediate fetch message to UICC processor 106. If the baseband processor 104 is not in a busy state, the method proceeds to 904.

At 904, based on a determination that baseband processor 104 is not in the busy state, baseband processor 104 sends a fetch message to UICC processor 106. The fetch message is sent in response to receipt of a proactive-command-pending message from the UICC processor 106. According to some aspects, the UICC of UE 102 is a proactive type UICC and baseband processor 104 may support proactive commands. When UICC has a proactive request to send to the baseband processor 104, it first sends a proactive-command-pending message to the baseband processor 104. Upon receiving the proactive-command-pending message, baseband processor 104 sends the fetch command to obtain the information corresponding to the proactive command. However, in some aspects, baseband processor 104 sends the fetch command to UICC processor 106 only when baseband processor 106 is not in a busy state.

At 906, baseband processor 104 receives a proactive-command message from the UICC processor 106. The proactive-command message corresponds to a request for single network slice selection assistance information (S-NSSAI) mapping information corresponding to one or more network slices. According to some aspects, the proactive-command message may be a set up event list proactive command requesting information corresponding to a slice status change event. According to some aspects, the proactive-command message may be to provide local information (PLI) command requesting information corresponding to rejected network slices with S-NSSAI mapping. According to some aspects, the proactive-command message may be a PLI command requesting information corresponding to network slices with S-NSSAI mapping.

According to some aspects, proactive PLI command may include a new command qualifier (e.g., an indicator tag) to handle the list of rejected slice information with or without mapping information. According to some aspects, the thirty-seventh byte of the terminal information may be used to indicate support of PLI rejected slice information with or without mapping information. Furthermore, proactive command PLI may include a command qualifier with a value of seventeen to request rejected slice information with or without mapping information.

At 908, baseband processor 104 sends, to the UICC processor 106, a response message with the S-NSSAI mapping information. According to some aspects, the response message may be a terminal response message comprising rejected slice information with S-NSSAI mapping. Alternatively, the response message may be an envelope command message comprising currently active S-NSSAI mapping information. Alternatively, the response message may be a terminal response message comprising rejected slice information with S-NSSAI mapping and currently active S-NSSAI mapping information.

According to some aspects, after receiving a proactive command PLI for slice information with S-NSSAI mapping, baseband processor 104 sends a terminal response with a list of rejected slices with S-NSSAI mapping along with the current served S-NSSAI list if available. According to some aspects, the response to the proactive PLI command (e.g., the terminal response from baseband processor 104) is extended to include current slice information such as the serving slice information, configured slice information, rejected slice information, and/or allowed slice with or without mapping information. According to some aspects, baseband processor 104 is expected to respond with rejected slice information, with or without mapping information, as well as the slices information with S-NSSAI mapping when a proactive command PLI slice information is received. According to some aspects, baseband processor 104 sends a terminal message to UICC processor 106 with configured slice information if available at baseband processor 104. However, if the configured slice information is unavailable at baseband processor 104, the response length is indicated by a value of zero in the terminal response.

According to some aspects, baseband processor 104 sends a terminal message to UICC processor 106 with information corresponding to allowed slices with mapping, if available at baseband processor 104. However, if the allowed slice information is unavailable at baseband processor 104, the response length is indicated by a value of zero in the terminal response.

Various aspects can be implemented, for example, using one or more computer systems, such as computer system 1000 shown in FIG. 10. Computer system 1000 can be any well-known computer capable of performing the functions described herein such as UE 102 of FIG. 1. Computer system 1000 includes one or more processors (also called central processing units, or CPUs), such as a processor 1004. Processor 1004 is connected to a communication infrastructure 10010 (e.g., a bus). Computer system 1000 also includes user input/output device(s) 1003, such as monitors, keyboards, pointing devices, etc., that communicate with communication infrastructure 1006 through user input/output interface(s) 1002. Computer system 1000 also includes a main or primary memory 1006, such as random access memory (RAM). Main memory 1008 may include one or more levels of cache. Main memory 1008 has stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 reads from and/or writes to removable storage unit 1018 in a well-known manner.

According to some aspects, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communication path 1026.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1000, main memory 1008, secondary memory 1010 and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 10. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication;
a universal integrated circuit card (UICC) processor; and
a baseband processor communicatively coupled to the UICC processor and the transceiver, wherein the baseband processor is configured to:
determine whether the baseband processor is in a busy state;
based on a determination that the baseband processor is not in the busy state, send a fetch message to the UICC processor, wherein the fetch message is sent in response to receipt of a proactive-command-pending message from the UICC processor;
receive a proactive-command message from the UICC processor, wherein the proactive-command message corresponds to a request for single network slice selection assistance information (S-NSSAI) information corresponding to one or more network slices; and
send, to the UICC processor, a response message with the S-NSSAI information.

2. The UE of claim 1, wherein the proactive-command message is a set up event list proactive command requesting information corresponding to a slice status change event.

3. The UE of claim 2, wherein the response message is an envelope command message comprising the S-NSSAI information that includes one or more of the following: currently serving S-NSSAI, configured S-NSSAI, rejected S-NSSAI with or without mapping information, or allowed S-NSSAI with or without mapping information.

4. The UE of claim 1, wherein the proactive-command message is a provide local information (PLI) command requesting information corresponding to rejected network slices.

5. The UE of claim 4, wherein the response message is a terminal response message comprising rejected slice information with mapping information or rejected slice information without mapping information.

6. The UE of claim 4, wherein the PLI command comprises a command qualifier corresponding to rejected slice information.

7. The UE of claim 4, wherein the PLI command comprises a command qualifier with a value of seventeen to request rejected slice information.

8. The UE of claim 1, wherein the baseband processor is further configured to:
send, to the UICC processor, a terminal profile message, wherein a first bit of a thirty-seventh byte of the terminal profile message indicates support of PLI rejected slice information.

9. A method of operating a user equipment (UE), comprising:
determining whether a baseband processor of the UE is in a busy state;
based on a determination that the baseband processor is not in the busy state, sending a fetch message, by the baseband processor, to a universal integrated circuit card (UICC) processor of the UE, wherein the fetch message is sent in response to receipt of a proactive-command-pending message from the UICC processor;
receiving, by the baseband processor, a proactive-command message from the UICC processor, wherein the proactive-command message corresponds to a request for single network slice selection assistance information (S-NSSAI) mapping information corresponding to one or more network slices; and
sending, to the UICC processor, a response message with the S-NSSAI mapping information.

10. The method of claim 9, the proactive-command message is a set up event list proactive command requesting information corresponding to a slice status change event.

11. The method of claim 10, wherein the response message is an envelope command message comprising the S-NSSAI information that includes one or more of the following: currently serving S-NSSAI, configured S-NSSAI, rejected S-NSSAI with or without mapping information, or allowed S-NSSAI with or without mapping information.

12. The method of claim 9, wherein the proactive-command message is a provide local information (PLI) command requesting information corresponding to rejected network slices.

13. The method of claim 12, wherein the response message is a terminal response message comprising rejected slice information with mapping information or rejected slice information without mapping information.

14. The method of claim 12, wherein the PLI command comprises a command qualifier with a value of seventeen to request rejected slice information.

15. The method of claim 9, further comprising:
sending, to the UICC processor, a terminal profile message, wherein first bit of thirty-seventh byte of the terminal profile message indicates support of PLI rejected slice information.

16. A non-transitory computer-readable medium (CRM) having instructions stored thereon that, when executed by a processor of a user equipment (UE), cause the UE to perform operations comprising:
determining whether a baseband processor of the UE is in a busy state;
based on a determination that the baseband processor is not in the busy state, sending a fetch message, by the baseband processor, to a universal integrated circuit card (UICC) of the UE, wherein the fetch message is sent in response to receipt of a proactive-command-pending message from the UICC processor;
receiving, by the baseband processor, a proactive-command message from the UICC processor, wherein the proactive-command message corresponds to a request for single network slice selection assistance information (S-NSSAI) mapping information corresponding to one or more network slices; and
sending, to the UICC processor, a response message with the S-NSSAI mapping information.

17. The non-transitory CRM of claim 16, the proactive-command message is a set up event list proactive command requesting information corresponding to a slice status change event.

18. The non-transitory CRM of claim 17, wherein the response message is an envelope command message comprising the S-NSSAI information that includes one or more of the following: currently serving S-NSSAI, configured S-NSSAI, rejected S-NSSAI with or without mapping information, or allowed S-NSSAI with or without mapping information.

19. The non-transitory CRM of claim 16, wherein the proactive-command message is a provide local information (PLI) command requesting information corresponding to rejected network slices.

20. The non-transitory CRM of claim 19, wherein the response message is a terminal response message comprising rejected slice information, with and or without mapping information, and one or more of the following: currently serving S-NSSAI information, allowed S-NSSAI with or without mapping information, or configured slice information.
